(19) United States
(12) Patent Application Publication
(10) Pub. No.: US 2023/0267787 A1
(43) Pub. Date: Aug. 24, 2023

(54) SITE ACCESS CONTROL UNIT

(71) Applicant: Intelligent Protection Management Group LTD, Sheffield (GB)

(72) Inventor: Rick BAILEY, Sheffield (GB)

(21) Appl. No.: 18/012,330

(22) PCT Filed: Jun. 22, 2021
(86) PCT No.: PCT/GB2021/051583

§ 371 Date: Dec. 22, 2022

(30) Foreign Application Priority Data
Jun. 22, 2020 (GB) 2009507.1

(51) Int. Cl. G07C 9/25; G07C 9/00; G06V 40/16

(52) U.S. Cl. CPC G07C 9/253; G07C 9/00563; G06V 40/171

(57) ABSTRACT

A site access control unit (100) comprising: a structure (102) defining at least one bay (104A), wherein the bay comprises a sensor arrangement (204, 208) configured for at least authentication of a user, wherein the site access control unit further comprises control apparatus (201) configured to: cause the sensor arrangement to scan the user (408, 410); obtain authentication clearance based on authentication data from the scan (408); and transmit an egress control signal (413) to a device (228, 230), for directing the user to leave the bay, when at least the authentication clearance is obtained.

### FIELD OF THE INVENTION

Embodiments of the present invention relate to a site access control unit, and to a corresponding control apparatus and method.

### BACKGROUND TO THE INVENTION

Turnstiles are commonly used to control access to railway stations, sports stadiums, construction sites, schools, and other access-controlled sites. Some turnstiles are capable of scanning Smart Cards, tickets or biometric data for the purpose of authentication and/or billing. Authentication refers to the process of verifying the identity of a user or a device. Some site operators and employers implement a policy that if a user is feeling unwell, they should stay at home without trying to enter the site. However, some users may present themselves while infected, which increases the risk of pathogen transmission to other site users.

### BRIEF DESCRIPTION OF VARIOUS EMBODIMENTS OF THE INVENTION

According to at least some embodiments of the invention, there is provided a site access control unit comprising: a structure defining at least one bay, wherein the bay comprises a sensor arrangement configured for at least authentication of a user, wherein the site access control unit further comprises control apparatus configured to: verify a number of occupants in the bay, based on information from a bay occupancy detector; cause the sensor arrangement to scan the user; obtain authentication clearance based on authentication data from the scan; and transmit an egress control signal to a device, for directing the user to leave the bay, when at least the authentication clearance is obtained. To reduce the spread of pathogens, the bay may comprise non-contact features such as door opening actuators, and/or a touch-free sensor arrangement. Additionally or alternatively, the bay may comprise a disinfectant spray system.

According to at least some embodiments of the invention, there is provided an apparatus for a site access control unit, the apparatus comprising at least one processor; and at least one memory including computer program code, the at least one memory and the computer program code configured to, with the at least one processor, cause the apparatus at least to perform: causing a verification of a number of occupants in a bay of the site access control unit, based on information from a bay occupancy detector; causing a scan of a user by a sensor arrangement of the bay of the site access control unit; obtaining authentication clearance based on authentication data from the scan; and transmitting an egress control signal to a device, for directing the user to leave the bay, when at least the authentication clearance is obtained.

According to at least some embodiments of the invention, there is provided a method of controlling a site access control unit, the method comprising: causing a verification of a number of units in a bay of the site access control unit, based on information from a bay occupancy detector; causing a scan of a user by a sensor arrangement of the bay of the site access control unit; obtaining authentication clearance based on authentication data from the scan; and transmitting an egress control signal to a device, for directing the user to leave the bay, when at least the authentication clearance is obtained.

According to at least some embodiments of the invention, there is provided a site access control unit comprising: a structure defining at least one bay, wherein the bay comprises a sensor arrangement configured for at least authentication, wherein the site access control unit further comprises control apparatus configured to: obtain pre-authentication clearance based on pre-authentication data from a pre-authentication sensor configured to enable pre-authentication of the user before the user enters the bay; cause the sensor arrangement to scan the user within the bay; obtain authentication clearance based on authentication data from the scan; and transmit an egress control signal to a device, for directing the user to leave the bay, when at least the authentication clearance is obtained. The control apparatus and a corresponding method may be claimed independently.

According to at least some embodiments of the invention, there is provided a portable site access control unit comprising: a structure defining at least one bay, wherein the bay comprises a sensor arrangement configured for authentication and health screening of a user, wherein the portable site access control unit further comprises control apparatus configured to: cause the sensor arrangement to scan the user; obtain authentication clearance based on authentication data from the scan; obtain health screening clearance based on health screening data from the scan; and transmit an egress control signal to a device, for directing the user to leave the bay, when at least both clearances are obtained.

According to at least some embodiments of the invention, there is provided an apparatus for a portable site access control unit, the apparatus comprising at least one processor; and at least one memory including computer program code, the at least one memory and the computer program code configured to, with the at least one processor, cause the apparatus at least to perform: causing a scan of a user by a sensor arrangement of a bay of the portable site access control unit; obtaining authentication clearance based on authentication data from the scan; obtaining health screening clearance based on health screening data from the scan; and transmitting an egress control signal to a device, for directing the user to leave the bay, when at least both clearances are obtained.

According to at least some embodiments of the invention, there is provided a method of controlling a portable site access control unit, the method comprising: causing a scan of a user by a sensor arrangement of a bay of the portable site access control unit; obtaining authentication clearance based on authentication data from the scan; obtaining health screening clearance based on health screening data from the scan; and transmitting an egress control signal to a device, for directing the user to leave the bay, when at least both clearances are obtained.

According to at least some embodiments of the invention, there is provided a site access control unit comprising: a structure defining at least one bay, wherein the bay comprises a sensor arrangement configured for at least authentication, wherein the site access control unit further comprises control apparatus configured to: cause the sensor arrangement to scan the user; obtain authentication clearance based on authentication data from the scan; and transmit an egress control signal to a device, for directing the user to leave the bay, when at least the authentication clearance is obtained.

According to at least some embodiments of the invention, there is provided computer software that, when executed, is arranged to perform any one or more of the methods described herein.

### BRIEF DESCRIPTION OF THE DRAWINGS

For a better understanding of various examples of embodiments of the present invention reference will now be made by way of example only to the accompanying drawings in which:

FIGS. 1A, 1B illustrate a plan view and a frontal elevation of a portable site access control unit, according to an example;

FIG. 2 schematically illustrates an example of a system;

FIGS. 3A, 3B schematically illustrate an example of a control apparatus, and a computer-readable storage medium; and

FIG. 4 schematically illustrates an example of a method.

### DETAILED DESCRIPTION OF VARIOUS EMBODIMENTS OF THE INVENTION

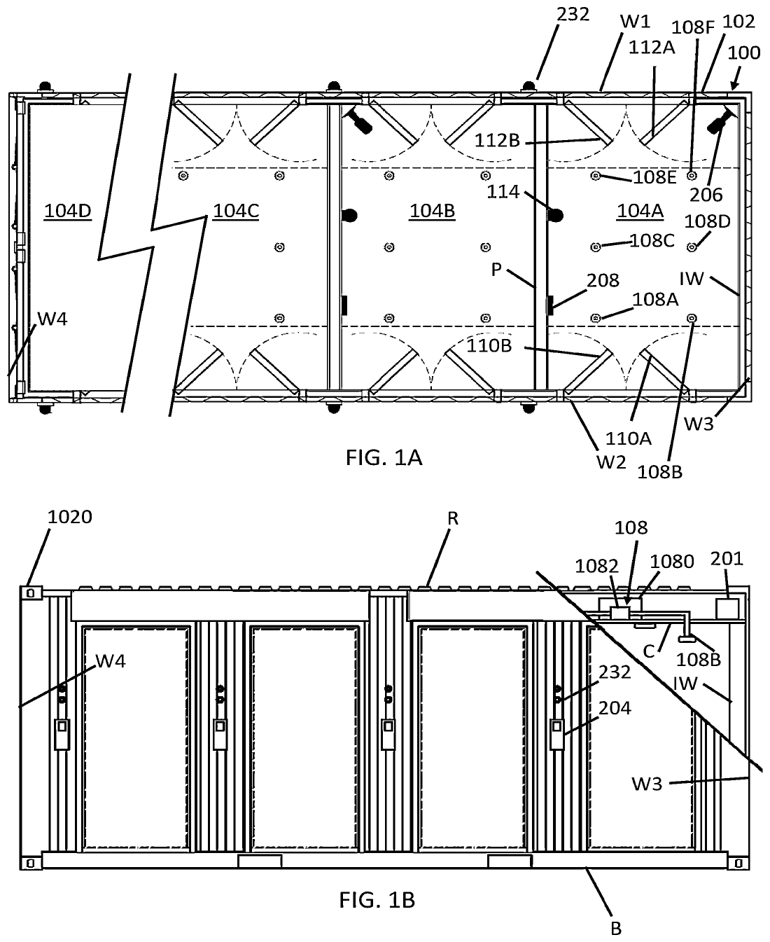

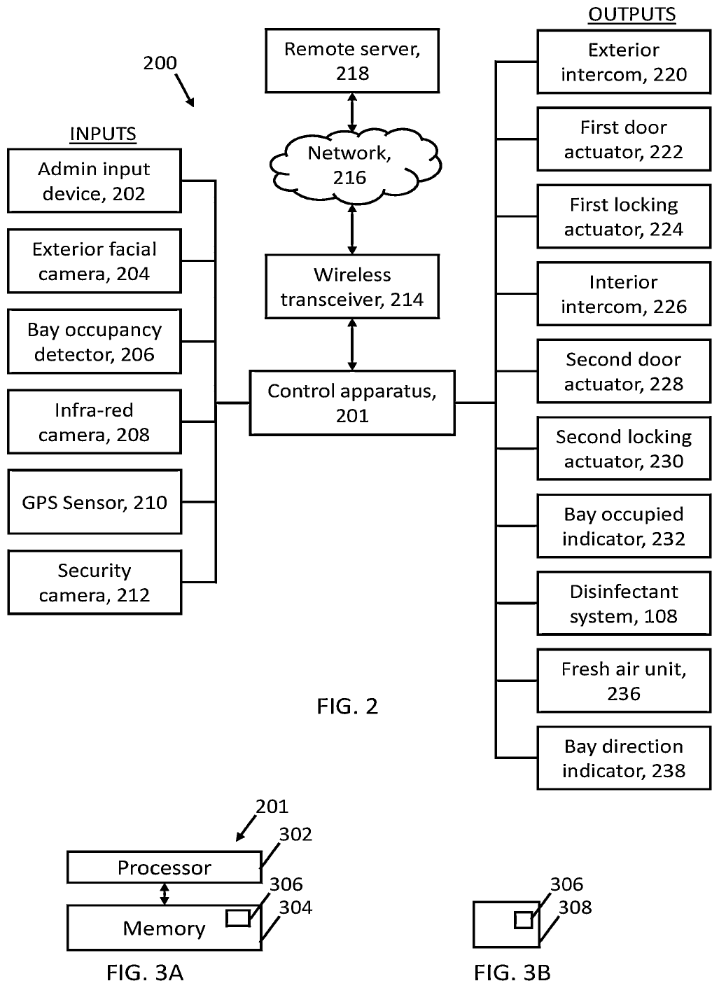

FIGS. 1A, 1B show a general arrangement of the portable site access control unit 100. FIG. 2 illustrates a system 200 comprising input devices, output devices, and control apparatus 201.

The portable site access control unit 100 comprises a structure 102 defining at least one bay 104A. The at least one bay 104A comprises a sensor arrangement of one or more sensors.

The sensor arrangement is configured for combined authentication and health screening of a user, as described later.

The illustrated structure 102 comprises at least two approximately parallel long walls W1, W2, and two approximately parallel short walls W3, W4 as shown in FIG. 1A. The structure 102 is optionally approximately rectangular in plan. The structure 102 may also comprise a base B (floor) and roof R as shown in FIG. 1B. These surfaces may be formed from a self-supporting sheet material such as corrugated steel.

The illustrated structure 102 may be an intermodal container, of the type used for shipping, road and rail transportation. The dimensions of an intermodal container expressed to two significant figures are: 2.4 metre width (8 ft); at least 2.6 metre height (8.5 ft); and at least 3.1 metre length (10 ft). Other standard lengths include 6.1 metres (20 ft), and 12.2 metres (40 ft).

The length depends on the number of required bays, because the bays 104A-104D are in series along the length dimension. The structure 102 could be offered in a variety of the standard lengths.

It would be appreciated that the specific dimensions of the structure 102 can vary. For portability, a width no greater than 2.6 metres is preferred. A length no greater than 12.5 metres is preferred. A height no greater than 3 metres is preferred. These maximum dimensions facilitate transportation on a standard-sized heavy goods vehicle.

The illustrated structure 102 has twistlock connectors 1020 at its corners, for portability. The structure 102 may also be stackable.

The interior of the structure 102 is separated into a plurality of bays 104A-104D. The bays may be separated from each other by interior partition walls P. A bay 104A is an area into which the user can enter to perform the screening, before being granted access to the site.

The bays 104A-104D may be arranged in a single row along the long wall, as shown in the plan view. A bay 104A may be rectangular in plan view. A bay 104A may be accessed from an ingress point (e.g. doorway/opening) in one of the long walls W1 or W2. A bay 104A may be exited from a separate egress point (doorway/opening) in the other of the long walls W2 or W1. This creates a one-way system, so that a user leaving the bay 104A does not have to come in proximity to queuing users.

A bay 104A may comprise doors 110A, 110B, 112A, 112B. The doors may be panels that can fully cover the openings (doorways) when closed, to seal the bay environment. The doors can optionally swing into the bay 104A, to reduce the chances of impact with a user standing outside the bay 104A. Optionally, the doors comprise double doors to reduce their incursion into the bay 104A. FIG. 1A shows double doors 110A, 110B at the ingress point, and double doors 112A, 112B at the egress point.

The doors 110A, 110B, 112A, 112B may be openable and/or closable automatically by door opening actuators 222, 228 as shown in FIG. 2. The user may not have direct control of the door opening actuators 222, 228. In an example, a bay 104A comprises a first set of one or more door opening actuators 222 configured to open a first set of one or more doors 110A, 110B at a first doorway associated with ingress to the bay 104A, and a second set of one or more door opening actuators 228 configured to open a second set of one or more doors 112A, 112B at a second doorway associated with egress from the bay 104A. By automatically opening doors, the user can pass through the bay 104A without touching surface and potentially depositing pathogens. This is significantly more hygienic than many turnstile designs, which may be touched by hundreds or thousands of users over a short period of time.

Additionally or alternatively, one or both sets of doors 110A, 110B or 112A, 112B may be lockable and unlockable automatically by door locking actuators 224, 230 as shown in FIG. 2. The door locking actuators 224, 230 restrict access to the site until the suitable clearances have been obtained. The user does not have direct control of the door locking actuators 224, 230. The door locking actuators 224, 230 may be electronically controllable dead bolts or the like. In an example, a bay 104A comprises a first set of one or more door locking actuators 224 configured to lock/unlock the first set of doors 110A, 110B, and a second set of one or more door locking actuators 230 configured to lock/unlock the second set of doors 112A, 112B.

The minimum doorway width for wheelchairs is 90 centimetres. The doorway width may preferably be at least one metre to permit easy wheelchair entry. Another wheelchair-accessible feature is the automatic door opening actuators 222, 228. The doors may optionally be opened by more than 90 degrees.

A bay 104A may be dimensioned to only permit one user to enter at a time. The bay 104A is at least as wide as its doorway(s). The bay width may be at least one metre, wherein its width dimension is along the dimension of the walls W1, W2. The bay width need not be any greater than 2 metres, to maximise the number of bays within a portable structure 102. In FIG. 1A, the bay width is just under 1.5 metres, so that four bays 104A, 104B, 104C, 104D will fit in a standard 20 ft (6.1 m) container as shown.

The exterior walls W1, W2, W3, W4, R and closed doors 110A, 110B, 112A, 112B of the structure 102 form an enclosure that isolates/seals the bays 104A-104D from an external environment. Interior walls 1W may be secured to the interior side of the walls W1, W2, W3, W4. An interior ceiling C may be suspended below the roof level, at least 2 metres above floor level.

A bay 104A is a volume defined by a set of interior walls 1W, at least one partition P, and the ceiling C. Insulation may be provided between the interior wall surfaces and the exterior walls. The insulation may be foam-based insulation, for example, or panel-based insulation. Sealant strips may create a seal between the doors 110A, 110B, 112A, 112B and the doorways. Therefore, a windy external environment will not disturb an internal environment of the bays 104A-104D. The bays 104A-104D may be fully sealed from each other, for example, the partitions P may be free from any uncovered through-holes, and sealed against the walls W1, W2 or IW and ceiling C.

The internal environment of the bays 104A-104D may be further controlled using an air handling unit 236. The air handling unit 236 may be a fresh air handling unit. A fresh air handling unit 236 is an active ventilation system that consumes energy to replace air in the bays 104A-104D with fresh outside air. The fresh air handling unit 236 may be always-on during operating hours, and may optionally be temporarily deactivated for cleaning operations as described later. The fresh air handling unit 236 may be configured not to recirculate air within a bay 104A, and not to pass the same air through multiple bays 104A-104D.

If the ceiling C is suspended, equipment such as electronic equipment, lighting circuitry and/or cleaning apparatus may be stored in the ceiling cavity, as shown in the corner cutout section of FIG. 1B. The ceiling C may comprise ceiling tiles, which may themselves be insulated panels. A removable ceiling tile and/or roof access hatch can enable access to the equipment.

The surfaces of the interior walls IW and/or partitions P may be configured to be easily cleanable, compared with painted plasterboard. For example, the surfaces may be faced with at least one sheet layer of a cleanable material. The cleanable material may be a resin (e.g. thermoset) material. Suitable examples include Melamine formaldehyde (‘melamine’) or Phenol formaldehyde resin (‘phenolic resin’).

To keep the bays 104A-104D sterile between uses, a disinfectant spray system 108 may be provided that does not require a human cleaner in the bays. The disinfectant spray system 108 may spray disinfectant around the bays 104A-104D. The disinfectant may be any fluid compliant with British/European Standard BS EN 1276, and/or BS EN 14476, or similar standards.

The disinfectant spray system 108 may comprise a plurality of disinfectant spray nozzles 108A-108F spatially distributed around a bay 104A, as shown in FIG. 1A. The Figure shows six disinfectant spray nozzles 108A-108F per bay 104A, however, a different number of nozzles could be provided. It is considered that at least three disinfectant spray nozzles with 360 degree spray patterns can cover the bay 104A. FIG. 1A shows that the disinfectant spray nozzles 108A-108F may be spaced in a regular array.

The disinfectant spray nozzles 108A-108F may be configured to atomize the disinfectant to emit a mist. The mist settles on substantially all surfaces of the bay 104A below ceiling level. The micrometer-scale mist droplets provide far more evenly distributed coverage than larger droplets, and evaporate quickly. The sealed environment of the bays 104A-104D helps the mist to spread evenly, without a prevailing breeze.

The disinfectant spray nozzles 108A-108F may be configured to emit a spray pattern having an angular width of at least 180 degrees, and optionally as wide as 360 degrees.

The disinfectant spray nozzles 108A-108F may be supported at a level below the level of the ceiling C and configured to spray downwardly and at least partially sideways but not to spray upwardly, to avoid wetting of ceiling-mounted electronic equipment such as lighting.

The disinfectant spray nozzles 108A-108F receive the disinfectant from a disinfectant tank 1080. FIG. 1B also schematically illustrates a hydraulic circuit 1082, for controlling flow of the disinfectant. The hydraulic circuit 1082 comprises at least a hydraulic valve for a bay 104A. Each bay 104A-104D may have an individually controllable hydraulic valve, so that unoccupied bays can be cleaned even though other bays remain occupied. The control apparatus 201 may be configured to open and to close the hydraulic valve. The hydraulic circuit 1082 may comprise a disinfectant pump for increasing a pressure of the disinfectant. The hydraulic circuit 1082 may comprise a manifold, for example a single valve may control flow to a plurality of disinfectant spray nozzles 108A-108F of a given bay 104A.

The disinfectant tank 1080 and/or hydraulic circuit 1082 may be located in the ceiling cavity, to increase potential energy for gravitational assistance. The disinfectant spray system 108 may be configured to be activated without user intervention, or at least without a human present in the bays 104A-104D. The control apparatus 201 is configured to transmit a disinfectant control signal to operate the disinfectant spray system 108. The disinfectant may be sprayed for a short duration of time, such as less than ten seconds.

The control apparatus 201 may determine to transmit the disinfectant control signal when a trigger condition occurs. It may be possible to manually trigger the disinfectant. However, the control apparatus 201 may advantageously monitor at least one parameter to determine the trigger condition without user intervention. A first example of the parameter is a timer. Disinfection may be performed at a predetermined frequency.

A second example of the parameter is based on a number of uses of a bay 104A or of the portable site access control unit 100. This can be expressed as a cumulative number of uses since the last disinfection, or another expression such as frequency. The number of uses could increment each time each time a user enters the bay 104A or exits the bay 104A, which the control apparatus 201 could determine based on clearance or based on a bay occupancy detector 206. In an example, the threshold number of uses may be set at a value greater than 20, such as 100 people.

A third example of the parameter is a health screening status of the user. If the health screening returns a negative outcome for a given user, the affected bay 104A may be disinfected after the user has left. In an implementation, a combination of the above parameters is monitored. Any one of the monitored parameters may be sufficient to act as a trigger.

If a bay 104A is not empty, the control apparatus 201 may defer the commencement of disinfectant spraying, e.g. by deferring transmission of the disinfectant control signal until the bay 104A is empty. The bay 104A can be determined to be empty in dependence on a clearance signal associated with egress, and/or based on a bay occupancy detector 206 as described later, or by other means. Unoccupied bays could be cleaned while others are occupied and not cleaned.

In some examples, the portable site access control unit 100 is configurable to spray disinfectant on the user, to kill any pathogens on the user's skin or clothing. The control apparatus 201 may therefore transmit the disinfectant control signal in dependence on obtaining one or more of the authentication clearances described herein, and/or one or more of the health screening clearances described herein. When the disinfectant control signal is transmitted, the control apparatus 201 may also transmit a temporary inhibit signal to the fresh air handling unit 236, to allow the mist to settle in static air.

The following description sets out how the bays are configured to be used, for controlling site access.

The interaction between the user and functions of the bay is governed by the control apparatus 201. According to FIG. 2, at least part of the control apparatus 201 may be connectable to an external network 216 via a router (not shown) and a wireless radio frequency transmitter and/or receiver and/or transceiver 214. Additionally or alternatively, the control apparatus 201 can connect to the network 216 in other ways, for example without a wireless link. The network connection enables remote network monitoring and/or control of one or more input/output devices of the system 200.

The sensor arrangement of a bay 104A may comprise a pre-authentication sensor 204 such as an exterior facial camera. The pre-authentication sensor 204 is configured to enable pre-authentication of the user before the user enters the bay 104A. This pre-authentication ensures that only authorised users can enter the bay, which protects the bay 104A against misuse, unauthorised entry, or vandalism. The term ‘exterior’ refers to the field of view of the sensor, wherein at least part of a user standing outside the bay 104A is visible. The pre-authentication sensor 204 may be located on an exterior wall of the bay 104A (W1 and/or W2), or behind a transparent panel.

The pre-authentication sensor 204 may be any suitable imaging sensor that can capture sufficient biometric details of at least part of user's face, in any suitable part of the electromagnetic spectrum that enables image recognition authentication. Examples include facial recognition cameras and retinal scanners.

A first benefit of the imaging sensor is that the user does not have to contact the sensor, reducing the spread of pathogens. A second benefit is that a greater level of security is offered compared to a card scanner or keypad. A card scanner can only authenticate the card rather than the user, because it cannot verify that the person possessing the card is the registered card holder.

The pre-authentication sensor 204 may be configured to transmit its sensed data to the control apparatus 201. In response, the control apparatus 201 obtains pre-authentication clearance. Two examples of obtaining pre-authentication clearance are given below.

In a first example, pre-authentication clearance is determined remotely. The control apparatus 201 transmits an authentication query to a server 218 via the network 216, based on the pre-authentication data from the pre-authentication sensor 204. The server 218 may be a cloud server, for example. The server 218 could be one entity or a distributed system. The server 218 stores an authentication access list linking facial/retinal biometric data to user identities. The authentication query may comprise the unprocessed pre-authentication data, or the control apparatus 201 may perform image processing and transmit processed pre-authentication data. The image processing may comprise facial/retinal recognition, and may comprise feature extraction. The server 218 receives the unprocessed or processed pre-authentication data. If unprocessed, the server 218 performs the image processing. The server 218 compares the processed pre-authentication data with stored facial/retinal biometric data to determine a closest match. A machine learning algorithm and/or probabilistic scheme may be used for the feature matching. The server 218 determines whether a positive match is found, and transmits a positive or negative result to the control apparatus 201.

In a second example, pre-authentication clearance is determined locally using a processor 302 of the control apparatus 201 (FIG. 3A). The local processor 302 performs the image processing and the comparison. A memory 304 of the control apparatus 201 may comprise a local copy of the authentication access list, to facilitate the local authentication.

In some examples, both local authentication and remote authentication are available in case of network dropouts. One copy of the local and remote authentication access lists is a master copy, e.g. server copy. The other copy is a slave copy. Updates are pushed or pulled via the network 216 on a periodic basis, to keep the slave copy synchronised with the master copy, to reflect additions or deletions to the authentication access list.

Following pre-authentication, the user can enter the bay 104A. This is facilitated by the control apparatus 201 transmitting at least one ingress control signal for directing the user to enter the bay 104A.

There are various ways of directing the user to enter the bay 104A. The first set of doors 110A, 110B may be controlled to direct the user to enter the bay 104A. For example, an ingress control signal may be transmitted to the first set of door locking actuators 224, to unlock the ingress point. Additionally or alternatively, an ingress control signal may be transmitted to the first set of door opening actuators 222, to open the ingress point. Additionally or alternatively, a visual and/or audible prompt may be rendered to the user.

If the control apparatus 201 obtains a negative pre-authentication result, the control apparatus 201 may transmit an output signal to at least one device for indicating the failure to the user and/or to a supervisor, without transmitting the ingress control signal. In an implementation, the control apparatus 201 may signal the failure by automatically initiating a communication session between the user and the supervisor, via communication devices. This enables the supervisor to provide remote support. One communication device is available to the user outside the bay 104A, and the other is remotely available to the supervisor. For example, the communication session may comprise a voice communication session. The communication device(s) may comprise an intercom 220. The intercom 220 may be to the exterior of the bay 104A, such as on wall W1 or W2. The session may be over a public telephone network, over Internet Protocol, or over a dedicated line.

In some implementations, the authentication access list may enable specified users to authenticate via a more private non-biometric method, such as scanning a barcode using the pre-authentication sensor 204 or a separate pre-authentication sensor. The barcode could be a matrix barcode displayed on a user's portable electronic device, for example. Therefore, different users may be able to authenticate using different techniques.

Assuming that pre-authentication clearance has been obtained and the first set of doors 110A, 110B has opened for ingress, the first set of doors 110A, 110B may remain open for a predetermined time of less than ten seconds, or until a bay occupancy detector 206 has detected user entry. A time of less than five seconds helps to support a high rate of throughput of users. The control apparatus 201 may then close the ingress doors 110A, 110B behind the user. The control apparatus 201 may then lock the ingress doors 110A, 110B behind the user.

A bay 104A may further comprise a bay occupation status indicator 232 visible from an exterior of the bay 104A, configured to indicate whether the bay 104A is occupied. An example of a bay occupation status indicator 232 is a light rendering device configured to display a first colour (e.g. red) or content if the bay 104A is occupied, and a second colour (e.g. green) or content if the bay 104A is unoccupied. The bay occupation status indicator 232 may be located by a same set of doors as the pre-authentication sensor 204.

Once the user enters the bay 104A, the control apparatus 201 may control the bay occupation status indicator 232 to display that the bay 104A is occupied, in dependence on the ingress control signal and/or data from the occupancy detector 206.

Once inside, the user cannot yet pass through the second set of doors 112A, 112B, without first performing at least an automatic health screening, in the controlled environment of the bay 104A. The second set of doors 112A, 112B may remain closed and locked during the health screening. In some examples, the user also has to perform a second automatic authentication, to ensure that the user being health-screened is the correct user.

Before the screening can begin, the control apparatus 201 may verify that the bay comprises the correct number of occupants. The control apparatus 201 may not enable scanning of the user until this verification is made. This prevents tailgating incidents and/or screening of the wrong user. Therefore, the interior of each bay 104A may comprise at least one bay occupancy detector 206. The bay occupancy detector 206 is any suitable sensor for detecting the number of occupants (density) of users in a given bay 104A. Examples of such sensors include visual cameras, wherein the control apparatus 201 may comprise an algorithm such as tailgating software for detecting whether more than one occupant has entered/is present. An alternative to a visual camera is an infrared/near-infrared laser detector. The control apparatus 201 may comprise tailgating software in conjunction with the bay occupancy detector 206. In some examples, two bay occupancy detectors 206 are provided, to provide a full field of view of both sets of doors 110A, 110B, 112A, 112B.

Part of the control apparatus 201 monitors data from the bay occupancy detector 206. An event may be triggered if a threshold density of users is exceeded. The threshold may be set to one occupant, or alternatively could be set to more than one occupant if an assistant is stationed in the bay 104A. If the threshold density is exceeded, the event trigger may cause the control apparatus 201 to start a process of correcting the situation. In an implementation, the control apparatus 201 may initiate a communication session with an interior communication device such as an interior intercom 226 in the bay 104A. Following a discussion with a supervisor, if it is decided that a user should exit the bay 104A, a door 110A, 110B of the bay 104A may be opened. If the supervisor is remote from the site, they could remotely transmit a door unlocking/opening signal via the network 216.

Once it is established that the correct number of users (e.g. one) is present in the bay 104A, the control apparatus 201 can cause an interior sensor 208 within the bay 104A to scan the user. The sensor arrangement of each bay 104A-104D comprises at least one interior sensor 208 that can perform the health screening and/or the second authentication screening within the bay. Both types of screening may be performed by a single sensor or by separate dedicated sensors within the bay. The sensor may be located on an interior wall IW or partition P, as shown in FIG. 1A.

In an implementation, the interior sensor is a single infrared/near-infrared camera can perform both types of screening. The infrared camera outputs thermal imaging data of at least part of a body of the user, such as their face or upper body. An elevated body temperature is a sign of possible sickness. The enclosed environment of the bay 104A ensures that the infrared camera does not detect the sun or other erroneous heat sources.

The authentication data refers to the part of imaging data from an interior sensor 208 that captures, in a field of view, the biometric features of the relevant part of the user's body, such as the face. The imaging data could be the same image as the thermal imaging data, or a different image from the same interior sensor, or a different image from a different interior sensor.

The health and authentication clearances are then obtained by the control apparatus 201. As described earlier for pre-authentication, the authentication clearance in the interior of the bay comprises an image processing step and a comparison step resulting in a positive or negative determination. The control apparatus 201 may perform one or both steps locally, or may transmit an authentication query to the server 218 comprising the processed or unprocessed authentication data. The control apparatus 201 obtains a positive or negative result in response. In some examples, a subset of users may be permitted to use other methods (e.g. barcode scanning) for authentication, as described earlier.

The health screening clearance comprises a processor 302 performing image processing of the thermal imaging data. The processor 302 determines a metric (e.g. peak/average) relating to a temperature of a portion of the image corresponding to part of the user. Image processing may help to identify which parts of the image correspond to the user. If the peak temperature exceeds a threshold, the processor 302 may make a negative determination. The threshold temperature may be a value greater than a normal body temperature of 37 Celsius. If the threshold is not exceeded, the processor 302 may make a positive determination. If exceeded, the determination may be negative.

The health screening image processing and resulting determination could be performed locally by the processor 302 of the control apparatus 201, without privacy issues because private data is not necessarily required. Alternatively, this process could be performed remotely by a processor of the server 218, by transmitting a health clearance query and receiving a positive or negative response.

In some implementations, a second health screening check may be performed. For example, the local or remote processor may perform a ‘mask check’ to determine whether the user is wearing a facial covering. A facial covering refers to a mask that at least covers the mouth, and in many cases the nostrils, to reduce the spread of airborne pathogens. This helps site operators to enforce policies that require users to wear a facial covering. The mask check can be performed by a processor 302 performing image processing of facial imaging data from an interior sensor 208. The image processing can use edge detection and/or facial feature detection algorithms to determine whether at least part of the user's face is covered/hidden, or whether a mask shape can be detected. If the authentication screening required the user to remove their facial covering, the mask check may be performed afterwards using a later-captured image, to ensure that the user has put their facial covering back on.

Once the control apparatus 201 has obtained both the authentication clearance and the health screening clearance(s), the user is allowed to leave the bay 104A and enter the site. Each type of clearance is necessary but not sufficient to allow access. It is only sufficient to be authenticated and to pass the health screening.

The above clearances can be obtained in a few seconds or less. Only one interior sensor 208 may be needed. Reliance on a reliable network connection can be reduced or eliminated by determining clearances locally.

When all of the relevant clearances have been obtained, the control apparatus 201 transmits an egress control signal to at least one device associated with egress, for directing the user to leave the bay 104A with granted site access.

There are various ways for the control apparatus 201 to direct the user to leave the bay 104A. In an implementation, the second set of doors 112A, 112B is controlled to direct the user to leave the bay 104A. An egress control signal may be transmitted to the second set of door locking actuators 230, to unlock the second set of doors 112A, 112B. An egress control signal may be transmitted to the second set of door opening actuators 228, to open the second set of doors 112A, 112B. The second set of doors 112A, 112B may be closed after a timer has expired or after egress has been detected. Additionally or alternatively, a visual and/or audible prompt may be rendered by a rendering device (not shown) inside the bay 104A, directing the user to leave the bay 104A at the egress point. During this process, the first set of doors 110A, 110B are not opened and may remain locked, to prevent truancy.

If the control apparatus 201 obtains at least one negative clearance result, the control apparatus 201 may transmit an output signal to at least one further device for indicating the failure to the user and/or to a supervisor, without transmitting the egress control signal. In an implementation, the control apparatus 201 may initiate a communication session between the user and the supervisor, via communication devices. This enables the supervisor to provide remote support. One communication device 226 is available to the user inside the bay 104A, and the other is remotely available to a supervisor. For example, the communication session may comprise a voice communication session. The communication device(s) may comprise an interior intercom 226. Following a discussion with the supervisor, if it is decided that a user should exit the bay 104A, the supervisor may operate input means to cause transmission of a door signal to one of the sets of door opening actuators 222, 228 and/or the corresponding door locking actuator 224, 230, to unlock and/or open the door, e.g. 110A, 110B. The supervisor could be remote, and the door signal could be received from the network 216.

A bay 104A may further comprise a hand dispenser 114 for dispensing disinfectant, so that the user can disinfect their hands before entering the site. The hand dispenser 114 may be an electronic dispenser comprising a proximity trigger, for touch-free dispensing.

Once the user has left the bay 104A, the control apparatus 201 may control the bay occupation status indicator 232 to display that the bay 104A is unoccupied, in dependence on data from the bay occupancy detector 206 to verify that nobody is present in the bay 104A. Another user can then use the bay 104A. Each user may only spend a few seconds in a bay.

In some implementations, the portable site access control unit 100 may be used for people leaving the site, not just those entering the site. A first subset of bays 104A-104D may be assigned to travel in a first direction, entering the site. A second subset of bays 104A-104D may be assigned to travel in the opposite direction, leaving the site. The assigned direction of travel through a bay 104A may be indicated by a direction indicator 238 visible from an exterior of the bay 104A. Direction indicators 238 may be symbolic, such as arrows or ticks/crosses, or textual. Direction indicators 238 may optionally be electronic displays. The electronic displays may be controllable by the control apparatus 201 and optionally over the network 216.

For travel in different directions, at least the first subset of bays 104A-104D comprises, at a first side (e.g. W1) of the portable site access control unit 100, their pre-authentication sensors 204 and/or bay occupation status indicators 232 and/or direction indicators 238 and/or exterior intercoms 220. At least the second subset of bays 104A-104D comprises, at a second different side (e.g. W2) of the portable site access control unit 100, their corresponding pre-authentication sensors 204 and/or bay occupation status indicators 232 and/or direction indicators 238 and/or exterior intercoms 220.

When a user is leaving the site, they may be required to perform an authentication. The user may be required to perform the same two authentications that were used to enter the site, or just one authentication via the interior sensor 208.

When a user is leaving the site, they may optionally be required to perform a health screening, depending on the implementation. This is useful if symptoms of an illness have appeared during their visit within the site. A site owner could then instruct the user not to visit the site the next day.

At least some bays 104A-104D may be direction-agnostic, permitting one-way flow in either direction. Therefore, a bay 104A may comprise pairs of exterior-facing devices, such as two pre-authentication sensors 204 and/or two bay occupation status indicators 232 and/or two direction indicators 238 and/or two exterior intercoms 220. One of each pair is visible/usable from a first side (e.g. W1) of the bay 104A, and the other of each pair is visible/usable from the second side (e.g. W2) of the bay 104A. The direction indicator 238 may be reversible, to change the direction of flow and therefore change which of these devices are in-use.

If a bay 104A is direction-agnostic, the control apparatus 201 may be configured assign a direction of flow. The automatic assignment could be dynamic. For example, the dynamic assignment could be based on a timer, to switch directions at different times of day. The dynamic assignment could be based on a frequency comparator, comparing a realtime frequency of site entries relative to site exits. The dynamic assignment could be controlled locally, or controlled remotely via the network 216. In an example use case, three bays could be for site entry and one for site exit, in the morning. In the evening, three bays could be for site exit, and one for site entry. The control apparatus 201 reverses the direction displayed by the direction indicator 238 of a bay 104A when the control apparatus 201 determines to reverse the bay direction.

The control apparatus 201 may be configured to track a time of entry to the site of the user and/or a time of exit from the site of the user. The control apparatus 201 may timestamp the user's time of entry to the site and time of exit from the site. The timestamp may be associated to a user identity based on the authentication, and stored in a database and/or transmitted for storage in a remote database.

The time of entry timestamp may be dependent on a time at which the clearance for egress from the bay 104A was obtained, because the user is already inside the bay and may not be able to turn around and leave via the ingress doors. For similar reasons, the time of exit timestamp may also be dependent on a time at which the clearance for egress from the bay 104A was obtained. Other implementations may allow for the time of entry/exit to be dependent on pre-authorisation prior to entering the bay. Entry and exit may be differentiated by checking a stored presence status of the user, and/or by determining whether the bay 104A is associated with entering or leaving the site.

The user may not necessarily exit the site via the same portable site access control unit 100 through which they entered. Therefore, the timestamp recordal may be handled by a server 218 to which a plurality of portable site access control stations is connected.

The timestamps may be recorded in a database in non-volatile memory. The timestamps may be transmitted to the network 216 for server storage. In some examples, the control apparatus 201 may comprise a local copy of the database in case of network disconnections, wherein the database is uploaded periodically to the server 218. In an alternative implementation, a server 218 may be wholly responsible for determining the timestamps.

The portable site access control unit 100 may comprise other useful features such as security features.

A first example of a security feature is a location sensor 210 configured to enable location tracking of the portable site access control unit 100. The location sensor 210 could be a Global Positioning System (GPS) sensor, for example. The location sensor 210 may report its location to the server 218 periodically or in response to a request. The location sensor 210 may receive power from an energy storage means such as a battery.

Another example of a security feature is an exterior security sensor 212 such as a security camera. The exterior security sensor 212 may be configured as a proximity sensor. The control apparatus 201 may be configured to trigger an alert if a condition is satisfied, such as detection of a geofence or line being crossed by an entity. The exterior security sensor 212 may be a line crossing sensor, for example. The alert and/or a video feed from the sensor may be transmitted to the server 218. The alert triggering may be activated outside of operating hours.

A bay 104A may further comprise a fire detector comprising a smoke detector and/or a heat detector, connected to at least some of the door locking actuators 224, 230 and/or door opening actuators 222, 228.

The portable site access control unit 100 may comprise an administrator input device 202. The administrator input device 202 may comprise any suitable local terminal at the site, such as a computer terminal, to enable authorised personnel to control one or more of the output devices 220, 222, 224, 226, 228, 230, 232, 108, 236, 238, and/or to monitor/control one or more of the input devices 202, 204, 206, 208, 210, 212.

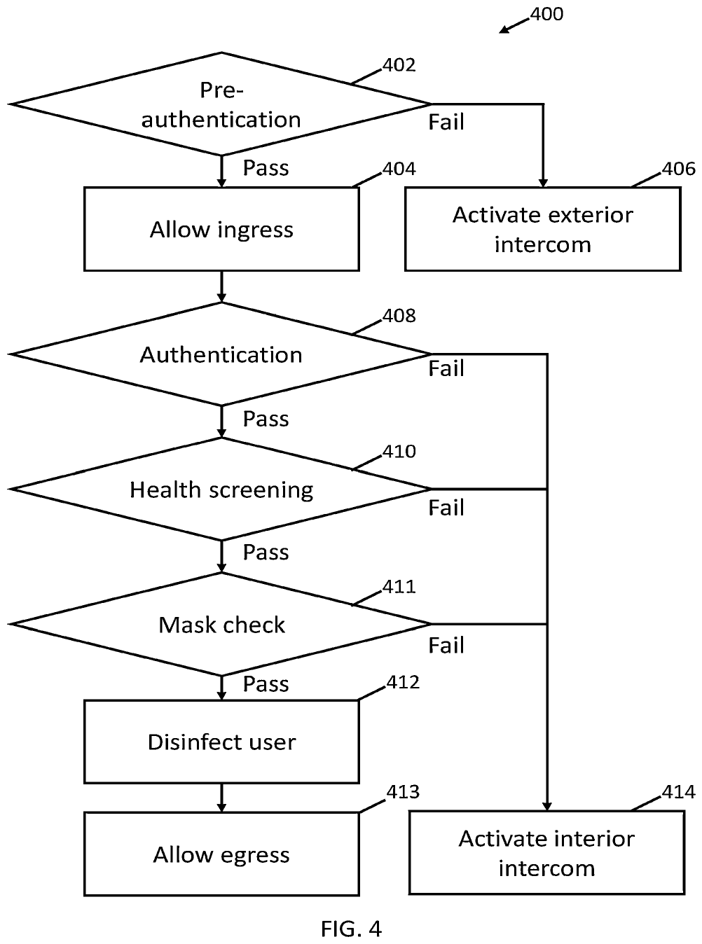

FIG. 4 is a flowchart summarising a control method performed by the control apparatus 201. Optional block 402 comprises causing a pre-authentication scan of a user by the pre-authentication scanner of the sensor arrangement of a bay 104A. The control apparatus 201 obtains authentication clearance to enter the bay 104A, based on pre-authentication data from the pre-authentication scan.

Optional block 404 comprises transmitting the ingress control signal to the at least one device associated with ingress, when at least the pre-authentication clearance is obtained. The at least one device may comprise the first set of door opening actuators 222 and/or the first set of door locking actuators 224, of the first set of doors 110A, 110B associated with ingress. This causes the first set of doors 110A, 110B to unlock and/or open. If the bay 104A is direction-agnostic, the control apparatus 201 may first check an assigned direction of one-way travel of the bay 104A, to determine which set of actuators to control.

If pre-authentication clearance is not obtained, the ingress control signal is not transmitted. Instead, optional block 406 may be performed, which comprises transmitting the output signal to the at least one device for indicating the failure to the user and/or the supervisor. For example, the exterior intercom 220 of the bay 104A may be activated.

Once the user is inside the bay 104A, blocks 408 and 410 comprise causing a scan of the user by the at least one interior sensor 208 of the sensor arrangement of the bay 104A, and obtaining the relevant clearances.

Block 408 comprises obtaining the authentication clearance based on the authentication data from the scan. The authentication data may be the image data of features of at least part of a face of the user. The control apparatus 201 may transmit the authentication query if the clearance is provided remotely. In some examples, the control apparatus 201 performs the image processing locally. If the clearance is determined locally, the control apparatus 201 may perform the comparison step, to determine the positive or negative outcome.

Block 410 comprises obtaining the health screening clearance based on the health screening data from the scan. The health screening data may be the thermal imaging data of at least part of the body of the user. The control apparatus 201 may perform the health screening image processing and the resulting determination. Alternatively, the control apparatus 201 may transmit the health screening query to the server 218 and receive the positive or negative response, if the clearance is provided remotely.

Optional block 411 comprises obtaining second health screening clearance, such as the indication that a facial covering is being worn by the user. The image processing and determination could be performed locally, or remotely at the server 218, based on a query.

Optional block 412 comprises transmitting a disinfectant control signal to activate the disinfectant spray system 108, if the user is to be disinfected. This could be performed at any time after the user has entered the bay 104A. If a mask check is performed, it is advantageous but not essential to perform the disinfection after the mask check, as the mask will be on the user.

Block 413 comprises transmitting the egress control signal to the at least one device associated with egress, when all of the required clearances (e.g. 408, 410) have been obtained. The at least one device associated with egress may comprise the second set of door opening actuators 228 and/or the second set of door locking actuators 230, of the second set of doors 112A, 112B associated with egress. This causes the second set of doors 112A, 112B to unlock and/or open.

If at least one of the clearances (408, 410, 411) is not obtained, the egress control signal is not transmitted. Instead, block 414 may be performed, which comprises transmitting the output signal to the at least one further device for indicating the failure to the user and/or the supervisor. For example, the interior intercom 226 of the bay 104A may be activated. The above-described automated approach advantageously enables a small number of remote supervisors to monitor a large number of bays and even a plurality of portable site access control units 100, potentially over a plurality of different sites.

It is important to note that the control apparatus 201 is not necessarily one centralized controller. Each component of FIG. 2 does not necessarily connect to each other component. The control apparatus 201 could refer to a plurality of distributed circuits that are dependent, semi-independent or fully independent of each other. Some circuitry could be built into specific input/output devices, whereas other circuitry could be standalone programmable logic controllers or general-purpose computer circuits. In other words, the term ‘control apparatus 201’ herein refers holistically to the electronic means associated with the portable site access control unit 100, that enables the overall system 200 to perform its intended functions. As shown in FIG. 3A, at least part of the control apparatus 201 incorporates at least one processor 302, and at least one memory 304 coupled to the at least one processor 302 and having computer program code 306 stored therein. The at least one memory 304 and the computer program code 306 are configured to, with the at least one processor 302, enable any one or more of the methods described herein to be performed. FIG. 3B illustrates a non-transitory computer-readable storage medium 308 comprising the computer program code 306. The blocks illustrated in FIGS. 2 and 4 may represent steps in a method and/or sections of code in the computer program 306. The illustration of a particular order to the blocks does not necessarily imply that there is a required or preferred order for the blocks and the order and arrangement of the block may be varied. Furthermore, it may be possible for some steps to be omitted. Although embodiments of the present invention have been described in the preceding paragraphs with reference to various examples, it should be appreciated that modifications to the examples given can be made without departing from the scope of the invention as claimed. For example. Although two authentications are described, the pre-authentication could be omitted so that only the interior authentication is performed. Alternatively, the interior authentication could be omitted, however, this would be less reliable at verifying that the user performing the health screening is the verified user. Some low-security implementations of the system may use a low-security card scanner/keypad, or no pre-authentication. Non hygiene-critical implementations may rely on a non-touchproof biometric sensor such as a fingerprint scanner. In some examples, different authentication techniques could be used for pre-authentication and interior authentication. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not. Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon. I/we claim:

1. A site access control unit comprising:
a structure having an interior and defining at least one bay, wherein the bay comprises a sensor arrangement configured to enable pre-authentication of a user via a pre-authentication sensor before the user enters the bay, and configured for at least authentication of the pre-authenticated user within the bay, wherein the site access control unit further comprises control apparatus configured to:
cause a pre-authentication scan of the user by the pre-authentication sensor;
obtain authentication clearance for the user to enter the bay, based on pre-authentication data from the pre-authentication scan;
transmit an ingress control signal to at least one device associated with ingress into the bay, when at least the pre-authentication clearance is obtained;
verify a number of occupants in the bay, based on information from a bay occupancy detector;
cause the sensor arrangement to scan the pre-authenticated user within the bay;
obtain authentication clearance based on authentication data from the scan of the pre-authenticated user within the bay; and
transmit an egress control signal to a device, directing the user to leave the bay, when the authentication clearance based on the authentication data from the scan of the pre-authenticated user within the bay is obtained.

2. The site access control unit of claim 1, wherein the control apparatus is configured to obtain health screening clearance based on health screening data from the scan of the pre-authenticated user within the bay, and is configured to transmit the egress control signal when both the authentication clearance based on the authentication data from the scan of the pre-authenticated user within the bay, and the health screening clearance, are obtained.

3. The site access control unit of claim 2, wherein the sensor arrangement comprises at least one image sensor in an interior of the bay, configured to:
provide the authentication data from the scan of the pre-authenticated user within the bay; and
provide the health screening data as thermal imaging data of at least part of a body of the user.

4. The site access control unit of claim 1, wherein the sensor arrangement comprises at least one image sensor in an interior of the bay, configured to:
provide the authentication data from the scan of the pre-authenticated user within the bay as image data of features of at least part of a face of the user.

5. The site access control unit of claim 1, wherein the control apparatus is configured to obtain an indication that a facial covering is being worn by the user, based on facial imaging data from the sensor arrangement, and wherein transmission of the egress control signal further requires the indication that a facial covering is being worn by the user.

6. The site access control unit of claim 1, comprising a plurality of bays separated from each other by partitions.

7. The site access control unit of claim 1, wherein the bay comprises separate ingress and egress points, to permit one-way passage therethrough.

8. The site access control unit of claim 1, comprising at least one of:
a first door opening actuator configured to open a first door of the bay to permit the user to enter the bay; or
a second door opening actuator configured to open a second door of the bay to permit the user to leave the bay, wherein the device to which the control apparatus is configured to transmit the egress control signal is the second door opening actuator.

9. The site access control unit of claim 8, wherein the control apparatus is configured to control the first and second door opening actuators to progressively:
open the first door to permit ingress, without opening the second door;
close the first door without opening the second door;
when at least the authentication clearance is obtained, transmit the egress control signal to open the second door, optionally without opening the first door;
close the second door, optionally without opening the first door; and
open the first door to permit ingress by a next user, without opening the second door.

10. The site access control unit of claim 9, wherein the control apparatus is configured to control at least one of the first door opening actuator, or the second door opening actuator, in dependence on a signal from the bay occupancy detector.

11. The site access control unit of claim 1, wherein the bay comprises at least one of:
a reversible direction indicator visible from an exterior of the bay, configured to indicate whether the bay is to be used for entering or leaving the site; or
a bay occupation status indicator visible from an exterior of the bay, configured to indicate whether the bay is occupied.

12. (canceled)

13. The site access control unit of claim 1, wherein the control apparatus is configured to transmit or store a timestamp associated with a user identity, when the authentication clearance based on the authentication data from the scan of the pre-authenticated user within the bay is obtained.

14. The site access control unit of claim 1, comprising at least one door locking actuator configured to lock a door of the bay, wherein the control apparatus is configured to cause the door locking actuator to unlock the door when the authentication clearance based on the authentication data from the scan of the pre-authenticated user within the bay is obtained.

15. The site access control unit of claim 1, wherein the structure is an enclosure configured to isolate the bay from an external environment.

16. The site access control unit of claim 1, comprising a disinfectant spray system configured to spray disinfectant around the bay, wherein the control apparatus is configured to transmit a disinfectant control signal to operate the disinfectant spray system.

17. The site access control unit of claim 16, wherein the disinfectant spray system comprises a plurality of disinfectant spray nozzles spatially distributed around the bay.

18. (canceled)

19. The site access control unit of claim 1, comprising a fresh air handling unit configured to actively ventilate the bay.

20. (canceled)

21. (canceled)

22. (canceled)

23. (canceled)

24. (canceled)

25. The site access control unit of claim 1, wherein the bay comprises a user communication device, and wherein the control apparatus is configured to initiate a communication session via the user communication device when the authentication clearance based on the authentication data from the scan of the pre-authenticated user within the bay has not been obtained.

26. An apparatus for a site access control unit, the apparatus comprising at least one processor; and at least one memory including computer program code, the at least one memory and the computer program code configured to, with the at least one processor, cause the apparatus at least to perform:
causing a pre-authentication scan of a user by a pre-authentication sensor before the user enters a bay by entering an interior of a structure of the site access control unit;
obtaining authentication clearance for the user to enter the bay, based on pre-authentication data from the pre-authentication scan;
transmitting an ingress control signal to at least one device associated with ingress into the bay, when at least the pre-authentication clearance is obtained;
causing a verification of a number of occupants in a bay of the site access control unit, based on information from a bay occupancy detector;
causing a scan of the pre-authenticated user within the bay by a sensor arrangement of the bay of the site access control unit;
obtaining authentication clearance based on authentication data from the scan of the pre-authenticated user within the bay; and
transmitting an egress control signal to a device, directing the user to leave the bay, when at least the authentication clearance based on authentication data from the scan of the pre-authenticated user within the bay is obtained.

27. A method of controlling a site access control unit, the method comprising:
causing a pre-authentication scan of a user by a pre-authentication sensor before the user enters a bay by entering an interior of a structure of the site access control unit;
obtaining authentication clearance for the user to enter the bay, based on pre-authentication data from the pre-authentication scan;
transmitting an ingress control signal to at least one device associated with ingress into the bay, when at least the pre-authentication clearance is obtained;
causing a verification of a number of occupants in a bay of the site access control unit, based on information from a bay occupancy detector;
causing a scan of the pre-authenticated user within the bay by a sensor arrangement of the bay of the site access control unit;
obtaining authentication clearance based on authentication data from the scan of the pre-authenticated user within the bay; and
transmitting an egress control signal to a device, directing the user to leave the bay, when at least the authentication clearance based on authentication data from the scan of the pre-authenticated user within the bay is obtained.

28. (canceled)

29. (canceled)
